(19) United States
(12) Patent Application Publication
(10) Pub. No.: US 2016/0255198 A1
(43) Pub. Date: Sep. 1, 2016

(54) PRIVATE BRANCH EXCHANGE

(71) Applicant: Panasonic Intellectual Property Management Co., Ltd., Osaka (JP)

(72) Inventors: Masayuki Mizumoto, Fukuoka (JP); Makoto Kataoka, Tokyo (JP)

(21) Appl. No.: 15/040,673

(22) Filed: Feb. 10, 2016

(30) Foreign Application Priority Data
Feb. 27, 2015 (JP) 2015-039032

(51) Int. Cl. H04M 3/51; H04M 3/22; H04M 3/46; H04M 3/42; H04M 3/02

(52) U.S. Cl. CPC H04M 3/5175; H04M 3/42323; H04M 3/02; H04M 3/46; H04M 3/2218; H04M 2203/551

(57) ABSTRACT

A PBX causes an external line button of an incoming alert target terminal to flash on and off when there is an incoming alert from an external line. The PBX saves log data to a log data storage area of a memory in a case in which a non-answer monitoring time expires without an agent of the terminal pressing the external line button of terminal. Thereafter, the PBX extracts log data stored in log data storage area and transmits the log data to manager terminal in a case in which manager terminal indicates the acquisition of report information to the PBX.

### BACKGROUND OF THE INVENTION

1. Field of the Invention

The present invention relates to a private branch exchange that transmits an incoming alert to a terminal which an agent that performs a telephone call answering service, operates in a case in which there is an incoming alert from an external communication terminal.

2. Description of the Related Art

In recent years, telephone call answering services in which an agent (an operator) that is present at a facility that is referred to as a call center, answers a telephone (an incoming alert) that has been received at the call center, have been widely known. Terminals (internal lines) that various agents operate, a Private Branch eXchange (PBX) that transfers (connects) an incoming alert to a terminal, and the like, are installed in a call center. For example, such a private branch exchange is disclosed in Japanese Patent Unexamined Publication No. 2014-158196.

When there is an incoming alert (a call) from a customer, the private branch exchange determines an incoming alert target terminal, and notifies the corresponding terminal of the incoming alert (flashing on and off of an external line button). When an agent of the corresponding terminal answers the incoming alert by pushing the external line button, the private branch exchange connects the external line to the corresponding terminal.

In addition, after the corresponding terminal has been notified of the incoming alert, in a case in which a predetermined non-answer monitoring time has expired prior to the agent of the corresponding terminal answering, the private branch exchange determines a subsequent incoming alert target terminal.

In addition, in a case in which a number of incoming alerts from customers exceeds the number of terminals that are capable of answering (a case in which there is not a free agent), a state in which a customer is made to wait for confirmation of the call is generated. Further, when there is an agent that is capable of answering, the private branch exchange transfers incoming alerts to the terminal of the corresponding agent in the order in which they are received.

However, private branch exchanges of the related art cannot display a report on a terminal of agent that hasn't answered. Therefore, it is not possible for a manager to be aware of an agent (a terminal) that is not answering incoming alerts from a customer.

### SUMMARY OF THE INVENTION

The present disclosure was devised in the light of the abovementioned features, and an object thereof is to provide a private branch exchange in which it is possible for a manager to be aware of an agent that is not answering telephone calls from a customer.

The private branch exchange according to the present disclosure is a private branch exchange that transfers an incoming alert to a terminal, which an agent that performs a telephone call answering service operates, in a case in which there is an incoming alert from an external communication terminal, and adopts a configuration that includes an incoming alert detection section that detects an incoming alert from an external line, and a controller that determines an incoming alert target terminal in a case in which an incoming alert is detected, and saves log data to a memory for each agent on the basis of each incoming alert.

According to the present disclosure, since the private branch exchange can save log data for each agent on the basis of each incoming alert, it is possible for a manager to be aware of an agent that is not answering telephone calls from a customer.

### BRIEF DESCRIPTION OF DRAWINGS

FIG. 1 is a block diagram that shows a configuration of an incoming alert answering system and a PBX (a private branch exchange) according to an embodiment of the invention;

FIG. 2 is a state diagram of when there is an incoming alert to a PBX of the incoming alert answering system in the embodiment of the invention;

FIG. 3 is a state diagram of when a speech path of the incoming alert answering system is formed in the embodiment of the invention;

FIG. 4 is a sequence diagram for describing the actions of the PBX in the embodiment of the invention;

FIG. 5A is a diagram that shows a display example of a report of a PBX of the related art; and

FIG. 5B is a diagram that shows a display example of a report of the PBX in the embodiment of the invention.

### DETAILED DESCRIPTION OF THE PREFERRED EMBODIMENT

Hereinafter, an embodiment of the invention will be described in detail with reference to the drawings as appropriate.

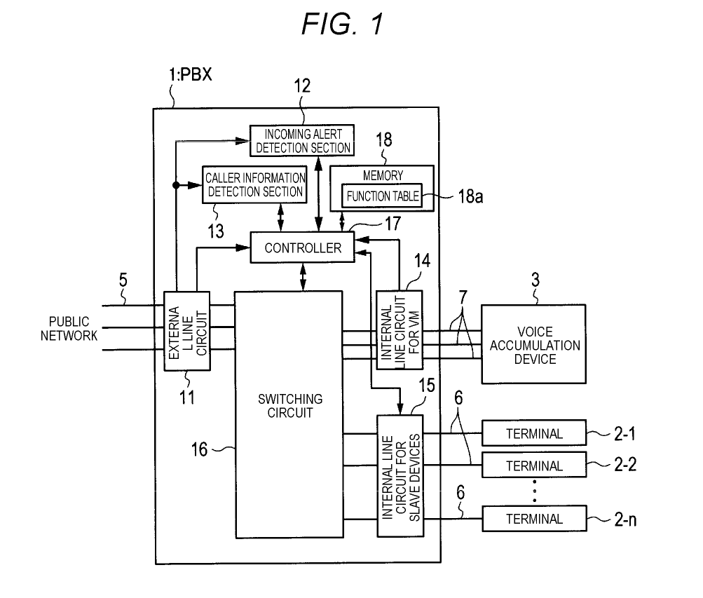

FIG. 1 is a configuration diagram of an incoming alert answering system and a PBX (a private branch exchange) in the embodiment of the invention. As shown in FIG. 1, the incoming alert answering system is configured by PBX 1, a plurality of terminals 2-1 to 2-n (n is a plural number), and voice accumulation device 3.

PBX 1 and each terminal 2-i (i is an integer from 1 to n) are connected by port 6. Voice accumulation device 3 is connected to PBX 1 by port 7, and performs a fixed voicemail service on an incoming alert.

Additionally, in a case of a digital PBX, control data is transmitted from a control channel (a D channel) that is provided in addition to a data channel (a B channel), which sends a voice signal.

Next, detailed description of PBX 1 will be given. PBX 1 includes external line circuit 11, incoming alert detection section 12, caller information detection section 13, internal line circuit for VM 14, internal line circuit for slave devices 15, switching circuit 16, controller 17, and memory 18, which includes function table 18a.

External line circuit 11 is connected to external line 5, and performs an incoming alert process and the transmission and reception of a voice signal. Incoming alert detection section 12 is connected to external line circuit 11, and detects an incoming alert from an external line. Additionally, incoming alert detection section 12 configures an external line trunk with external line circuit 11.

Caller information detection section 13 is connected to external line circuit 11, and detects caller information from external line 5. In a case in which caller information is a calling number, a telephone number of a customer that called is the caller information, and a sent call setting message, a calling number, which is sent using a modem signal in a case of an analog circuit, or the like, is extracted by caller information detection section 13.

Internal line circuit for VM 14 performs the transmission and reception of voice with voice accumulation device 3. Internal line circuit for slave devices 15 performs the transmission and reception of voice with terminal 2-i. Switching circuit 16 is connected to external line circuit 11, internal line circuit for VM 14 and internal line circuit for slave devices 15, and performs the opening and closing of speech paths. Additionally, in a case in which port 6 and port 7 are shared, internal line circuit for VM 14 and internal line circuit for slave devices 15 are a shared internal line circuit.

Controller 17 controls internal line circuits 14 and 15, external line circuit 11, and switching circuit 16. Controller 17 are function realization means that realize various functions by loading a control program in a central control device (a CPU), and the control program is contained in memory 18. In addition, a service request order, which activates a switching equipment function that PBX 1 performs, is registered in the function table 18a of memory 18.

In PBX 1 that is configured in this manner, when there is an incoming alert from external line 5, incoming alert detection section 12 detects the incoming alert via external line circuit 11, and the caller information is simultaneously detected by caller information detection section 13. Next, PBX 1 determines an incoming alert target from among terminals 2-1 to 2-n, and an external line button of terminal 2-i is caused to flash on and off. Subsequently, an incoming alert signal, which includes the caller information and an incoming alert external line port number is transmitted to voice accumulation device 3 using port 7.

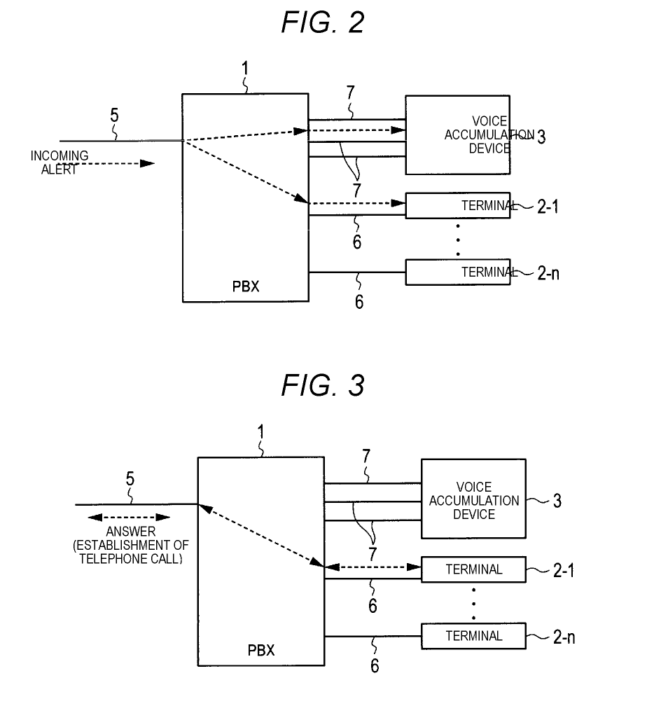

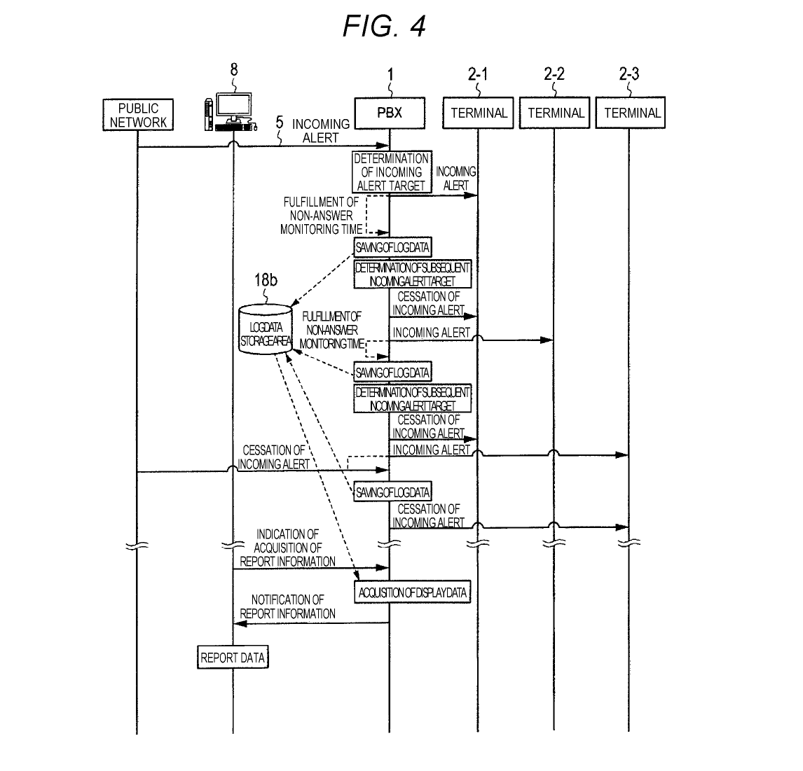

Next, the actions of the incoming alert answering system of the present embodiment will be described using FIGS. 2 and 3. FIG. 2 is a state diagram of when there is an incoming alert to PBX 1 of the incoming alert answering system in the present embodiment. FIG. 3 is a state diagram of when a speech path of the incoming alert answering system is formed in the present embodiment.

As shown in FIG. 2, when there is an incoming alert from external line 5, incoming alert detection section 12 of PBX 1 detects the incoming alert, and the caller information is detected by caller information detection section 13. Next, e controller 17 of PBX 1 indicates reproduction to voice accumulation device 3. Voice accumulation device 3 reproduces and outputs an automatic guidance message and music to external line 5 via PBX 1.

Controller 17 of PBX 1 simultaneously determines incoming alert target terminal 2-i, and causes an external line button of terminal 2-i to flash on and off. Subsequently, the controller 17 transmits an incoming alert signal, which includes the caller information and an incoming alert port number to voice accumulation device 3.

If an agent (an operator) presses the external line button (not illustrated in the drawing) of terminal 2-i in the state of FIG. 2, as shown in FIG. 3, a speech path is formed as a result of PBX 1 transmitting an answer signal to the incoming alert. At this time, the controller 17 of PBX 1 indicates the cessation of reproduction to voice accumulation device 3.

Additionally, when the agent is not near to terminal 2-i, and a predetermined period of time elapses after a call (expiry of a non-answer monitoring time), the controller 17 of PBX 1 determines a subsequent incoming alert target terminal 2-j (j is an integer from 1 to n other than i), and causes the external line button of terminal 2-j to flash on and off.

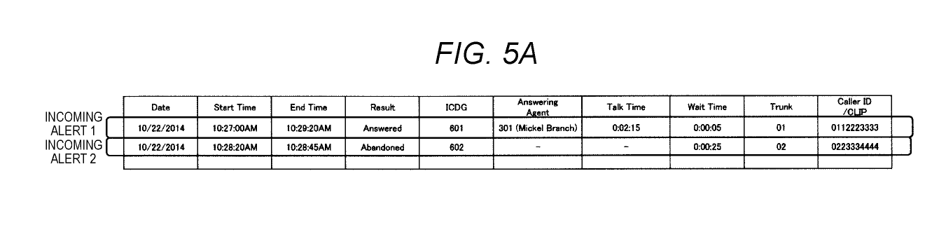

Next, the actions of PBX 1 of the present embodiment will be described using the sequence diagram of FIG. 4.

In FIG. 4, firstly, a case in which there is an incoming alert from external line 5 to PBX 1, is shown. PBX 1 determines terminal 2-1 as the incoming alert target, and causes the external line button of terminal 2-1 to flash on and off (an incoming alert).

In this instance, a case in which the non-answer monitoring time expires without the agent of terminal 2-1 pressing the external line button of terminal 2-1, is shown. In this case, PBX 1 saves the log data in log data storage area 18b of memory 18. Further, PBX 1 determines terminal 2-2 as the subsequent incoming alert target, causes the external line button of terminal 2-1 to stop flashing on and off (cessation of incoming alert), and causes the external line button of terminal 2-2 to flash on and off (an incoming alert).

Subsequently, in the same manner, if the non-answer monitoring time expires without the agent of terminal 2-2 pressing the external line button of terminal 2-2, PBX 1 saves the log data in log data storage area 18b of memory 18. Further, PBX 1 determines terminal 2-3 as the subsequent incoming alert target, causes the external line button of terminal 2-2 to stop flashing on and off (cessation of incoming alert), and causes the external line button of terminal 2-3 to flash on and off (an incoming alert).

Subsequently, if the incoming alert from external line 5 is ceased prior to the agent of terminal 2-3 pressing the external line button of terminal 2-3 (answering of incoming alert), PBX 1 saves the log data in log data storage area 18b of memory 18, and causes the external line button of terminal 2-3 to stop flashing on and off (cessation of incoming alert).

Thereafter, PBX 1 extracts log data stored in log data storage area 18b and transmits the log data to manager terminal 8 (notification of report information) in a case in which manager terminal 8 indicates the acquisition of report information to PBX 1 (indication of report information acquisition).

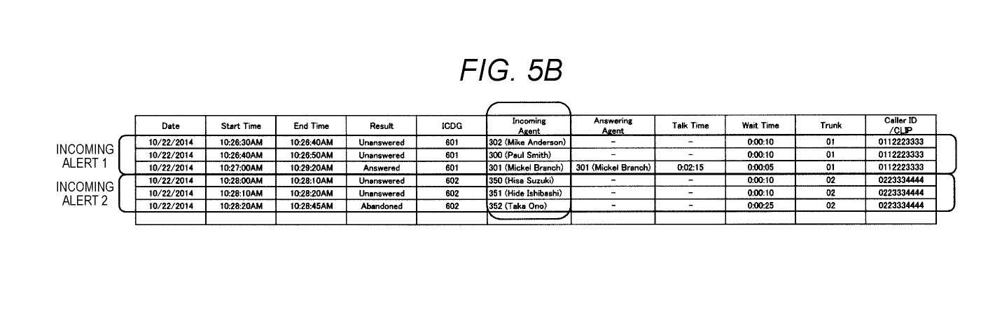

Next, the content of a report of PBX 1 of the present embodiment will be described using FIGS. 5A and 5B. FIG. 5A is a diagram that shows a display example of a report of a PBX of the related art, and FIG. 5B is a diagram that shows a display example of a report of the PBX in the present embodiment.

As shown in FIG. 5A, in the PBX of the related art, the log data is stored for each incoming alert.

Accordingly, in the PBX of the related art, it is not possible for a manager to be aware of an agent that is not answering telephone calls from a customer.

Additionally, in the log data there is information for an incoming alert day (Date), an incoming alert start time (Start Time), an incoming alert end time (End Time), an incoming alert result (Result), an incoming alert identification number (ICDG), an answering agent name (Answering Agent), a talk time (Talk Time), a wait time (Wait Time), a trunk line (Trunk), agent identification information (Caller ID/CLIP), and the like, of each incoming alert.

Meanwhile, as shown in FIG. 5B, in PBX 1 of the present embodiment, log data relating to each incoming alert is stored for each agent.

Accordingly, since at least an incoming alert start time, an incoming alert end time, and an incoming alert result are recorded for each agent of an incoming alert, it is possible for a manager to be aware of an agent that is not answering telephone calls from a customer.

Additionally, in the log data there is information for an incoming alert day (Date), an incoming alert start time (Start Time), an incoming alert end time (End Time), an incoming alert result (Result), an incoming alert identification number (ICDG), an incoming alert agent name (Incoming Agent), an answering agent name (Answering Agent), a talk time (Talk Time), a wait time (Wait Time), a trunk line (Trunk), agent identification information (Caller ID/CLIP), and the like, of each agent (terminal) for each incoming alert.

In the abovementioned manner, according to the present embodiment, since PBX 1 can save log data for each agent on the basis of each incoming alert, it is possible for a manager to be aware of an agent that is not answering telephone calls from a customer.

What is claimed is:

1. A private branch exchange that transfers an incoming alert to a terminal, which an agent that performs a telephone call answering service operates, in a case in which there is an incoming alert from an external communication terminal, the private branch exchange comprising:
an incoming alert detection section that detects an incoming alert from an external line; and
a controller that determines an incoming alert target terminal in a case in which an incoming alert is detected, and saves log data to a memory for each agent on the basis of each incoming alert.

2. The private branch exchange according to claim 1,
wherein at least an incoming alert start time, an incoming alert end time, and an incoming alert result are stored in exchange system log data for each incoming alert target agent.

3. The private branch exchange according to claim 1,
wherein the controller saves the log data to the memory at a timing at which a predetermined non-answer monitoring time has expired after transferring the incoming alert to an incoming alert target terminal, and at a timing at which the corresponding incoming alert is ceased.

4. The private branch exchange according to claim 1,
wherein the controller determines a subsequent incoming alert target terminal when a call to a terminal to which an incoming alert was transferred times out as a result of a predetermined period of time elapsing.

5. A communication system comprising:
a plurality of terminals;
a private branch exchange that transfers an incoming alert to a terminal, which an agent that performs a telephone call answering service operates, in a case in which there is an incoming alert from an external communication terminal; and
a manager terminal,
wherein the private branch exchange is provided with
an incoming alert detection section that detects an incoming alert from an external line, and
a controller that determines an incoming alert target terminal in a case in which an incoming alert is detected, and saves log data to a memory for each agent on the basis of each incoming alert, and
wherein the private branch exchange extracts the log data and transmits the log data to the manger terminal in a case in which the manager terminal indicates the acquisition of report information to the private branch exchange.

6. The communication system according to claim 5,
wherein the plurality of terminals are provided with a button which displays that an incoming alert is transferred from the private branch exchange.

7. A communication method that uses a private branch exchange that transfers an incoming alert to a terminal, which an agent that performs a telephone call answering service operates, in a case in which there is an incoming alert from an external communication terminal,
wherein the private branch exchange
detects an incoming alert from an external line,
determines an incoming alert target terminal in a case in which an incoming alert is detected, and saves log data to a memory for each agent on the basis of each incoming alert.
